(19) United States
(12) Patent Application Publication
(10) Pub. No.: US 2003/0193395 A1
(43) Pub. Date: Oct. 16, 2003

(54) Allocation of network bandwidth and prioritization in networks

(76) Inventors: Yavuz Ahiska, Esher (GB); Mehmet Bilgay Akhan, Egham (GB); Peter Middleton, Knaphill (GB)

Correspondence Address: SAWYER LAW GROUP LLP, P.O. Box 51418, Palo Alto, CA, 94303, US

(21) Appl. No.: 10/408,525

(22) Filed: Apr. 7, 2003

Related U.S. Application Data
(60) Provisional application No. 60/371,697, filed on Apr. 10, 2002.
(60) Provisional application No. 60/384,656, filed on May 30, 2002.

(51) Int. Cl. G08B 21/00

(52) U.S. Cl. 340/540; 340/530; 370/468; 375/240

(57) ABSTRACT

A method and system for allocating network bandwidth under alarm conditions. In one aspect, a method of the present invention for allocating network bandwidth to nodes on a network under alarm conditions includes determining that an alarm condition exists for at least one node on the network, and causing an increase in the network bandwidth allocation of the at least one node having the alarm condition. In other aspects, bandwidth requirements of the alarmed node are determined and used in allocating the increased bandwidth.

### CROSS REFERENCE TO RELATED APPLICATIONS

The present application claims the benefit of: U.S. Provisional Patent Application No. 60/371,697, filed Apr. 10, 2002, entitled, “Efficient Use of Bandwidth and Prioritisation in Security Networks,” and U.S. Provisional Patent Application No. 60/384,656, filed May 30, 2002, entitled, “Efficient Use of Bandwidth and Prioritisation in Security Networks,” both of which are incorporated herein by reference in their entireties.

### FIELD OF THE INVENTION

The present invention relates to techniques for the allocation of network bandwidth in networks, and more particularly to the allocation of network bandwidth and prioritization in networks under alarm conditions.

### BACKGROUND OF THE INVENTION

Communication networks allow data to flow between computer systems or other devices according to available bandwidth. Since network bandwidth is inherently limited, the amount of data going to particular network destinations must be allocated according to specific criteria.

Alarm conditions can occur in systems that have components connected via a network. For example, a security system can include networked computers and cameras which can send and receive video and audio data captured at different physical locations. An alarm in such a security system may be set off when an unauthorized motion or person is detected at a particular alarm location corresponding to a network node. It is essential during such an alarm condition that data from the alarm location be transferred to the desired device on the network which can act appropriately to the alarm. In another example, any one of multiple networked medical devices, or of automated devices on a production or assembly line, may pose an alarm condition if it fails during operation.

For existing networks, there is no predetermined escalation method in the prior art that will allow alarmed nodes to use more of the available network bandwidth. For example, in U.S. Pat. No. 6,091,777, Guetz describes a method of allocating dynamically network bandwidth in accordance with the current limitations on the bandwidth. In this method, when the network bandwidth has gone down for reasons beyond the control of the node, the node increases the compression ratio in line with the reduction in the network bandwidth. Although this method has advantages in attaining the optimum use of a given network bandwidth, it does not address the central question of how the network and the node should behave under alarm conditions. For example, under alarm conditions, using this methodology, if the network bandwidth were low, the video data could be compressed to unacceptable levels.

In U.S. Pat. No. 6,343,085, Krishnan describes a method of network bandwidth throttling system that assigns network bandwidth between virtual devices. The throttling system uses predetermined thresholds in order to attain a given bandwidth usage. Krishnan's method has instruments for measuring the bandwidth usage and throttles the bandwidth in an adaptive and hierarchical manner. This method fails to address the requirements during an alarm condition in which the network bandwidth usage must be reviewed immediately with the requirements of the current alarm condition.

Thus, networks having network nodes that are alarmed have no predetermined escalation method in the prior art that allows the alarmed nodes to use more of the available network bandwidth. This may not be a serious problem when the amount of data to be transmitted during an alarm is not large. However, when video or audio is to be transmitted, the requirements for network bandwidth increases substantially. For example, in networked closed-circuit television (CCTV) systems, unhindered transmission and reception of video is essential, particularly during alarm conditions. In applications such as medical and process control, video and audio data are used increasingly on the networks and the transmission and reception of such video and audio data under alarm conditions are essential.

### SUMMARY OF INVENTION

The invention provides a method and system of allocating network bandwidth to nodes that are alarmed. In one aspect, a method of the present invention for allocating network bandwidth to nodes on a network under alarm conditions includes determining that an alarm condition exists for at least one node on the network, and causing an increase in the network bandwidth allocation of the at least one node having the alarm condition.

In another aspect, a method of the present invention for allocating network bandwidth to nodes on a network having one or more alarm conditions includes determining a priority level for each alarm condition detected on the network, determining bandwidth requirements for nodes on the network which have an alarm condition, and causing an increase in network bandwidth allocation for each node having an alarm condition, where the increased bandwidth is in accordance with the bandwidth requirement and the priority level of the alarm condition.

In another aspect, a method of the present invention for allocating network bandwidth to nodes on a network includes determining a priority level of an alarm condition detected at one or more nodes on the network, assigning bandwidth requirements to each node having an alarm condition, where the bandwidth requirements are based, at least in part, on the priority level of the associated alarm condition, and causing an allocation of additional bandwidth to the one or more nodes having the alarm condition, the amount of additional bandwidth being in accordance with the bandwidth requirement of the node having the alarm condition.

In another aspect of the present invention, a system for allocating network bandwidth to nodes on a network includes means for determining that an alarm condition exists for at least one node on the network, and means for causing the increase of the network bandwidth allocation of the at least one node having the alarm condition.

In another aspect of the present invention, a computer readable medium includes program instructions allowing a computer to allocate network bandwidth to nodes on a network under alarm conditions. The program instructions perform steps including determining that an alarm condition exists for at least one node on the network, and causing an increase in the network bandwidth allocation of the at least one node having the alarm condition.

The present invention allows a network to achieve higher communication efficiency and effectiveness during emergency or alarm conditions, thereby greatly assisting in the effective handling of the alarm, whether for security, medical, or other types of purposes. Furthermore, the present invention provides even greater effectiveness when alarm conditions require the transmission of large amounts of data, such as video and audio data.

### BRIEF DESCRIPTION OF THE DRAWINGS

FIG. 1 is a block diagram of a network having nodes for use with the present invention;

FIG. 2 is a table illustrating an example of priority level assignment to different alarm conditions;

FIG. 3 is a table illustrating an example of node priority assignment after a conflict of priorities during an alarm condition; and

FIG. 4 is a flow diagram illustrating a method of the present invention for allocating network bandwidth during alarm conditions.

### DETAILED DESCRIPTION OF PREFERRED EMBODIMENTS

The present invention relates to techniques for the allocation of network bandwidth in networks, and more particularly to the allocation of network bandwidth and prioritization in networks under alarm or emergency conditions. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

Embodiments and examples of the present invention are described below. While particular applications and methods are explained, it should be understood that the present invention can be used in a wide variety of other applications and with other techniques within the scope of the present invention.

The present invention provides a system and method for allocating network bandwidth when the network is under alarm conditions. On existing networks, there is no predetermined escalation method in the prior art that will allow alarmed nodes to use more of the network bandwidth.

In the present invention, the network bandwidth is managed in accordance with priorities of alarm conditions occurring on the network. When a network node has an alarm, that node is allowed to use more of the given network bandwidth to service the alarm condition, at the expense of bandwidth for other nodes or users on the network that do not have an alarm (or which have a lower alarm priority).

The alarm conditions which lead to an alarm and reallocation of network bandwidth in the present invention may occur under many circumstances. In a security network, such as used in a private commercial premises, such alarm conditions can include an unauthorized entry onto a monitored premises, e.g., a break-in through a locked entrance. Or, the alarm conditions can include undesirable behavior by a group or individuals amounting to a security problem, such as a person that will not leave the premises, or a brawl between many persons. The alarm conditions might include destructive elements on a premises, such as smoke or fire, or in the environment, such as an earthquake. In some types of networks, alarm conditions can include medical emergencies, such as a person having a sudden heart attack; or equipment failure, such as medical equipment failing during a medical procedure or assembly line equipment failing during production. A wide variety of other circumstances can be defined as alarm conditions, depending on the circumstances and intended uses of the alarm system.

The alarm conditions can be sensed in a variety of ways. For example, contact closures such as microswitch-based door opening sensors are common sources of alarms in industrial and domestic security installations, e.g., on doors or windows. Other types of hardware sensors, such as optical (infrared, etc.), temperature, chemical, magnetic, force/acceleration, etc., can be used. In addition, alarms relying on software sensors are becoming more common, i.e., software processing of sensor data can determine if an alarm should be triggered. In CCTV equipment, for example, motion is commonly detected using software sensors, e.g., Video Motion Detection, where software can determine motion by examining frames recorded by a camera. Another example of a software-based alarm is smoke and fire detection by processing the video captured from a camera to determine if smoke or fire images are present in the video. Alarm condition hardware and/or software processing is also common in medical and process control equipment. For the present invention, the source of the alarms and the type of alarms can be of a wide variety including virtually any possible source and type, since the source and type of the alarms do not influence the processing under alarm conditions according to the invention.

Some examples of the invention will now be described. These are examples and should not be construed as limiting the scope of the invention. The block diagrams, tables, and flow diagrams illustrated herein can be implemented using software on a suitable general-purpose computer(s), electronic controller device(s), processor(s), or the like, preferably having microprocessor(s), memory, and appropriate peripherals, where the software is implemented with program instructions stored on a computer readable medium (memory device, CDROM or DVDROM, magnetic disk, etc.). The diagrams and tables can alternatively be implemented using hardware (logic gates, etc.) or a combination of hardware and software.

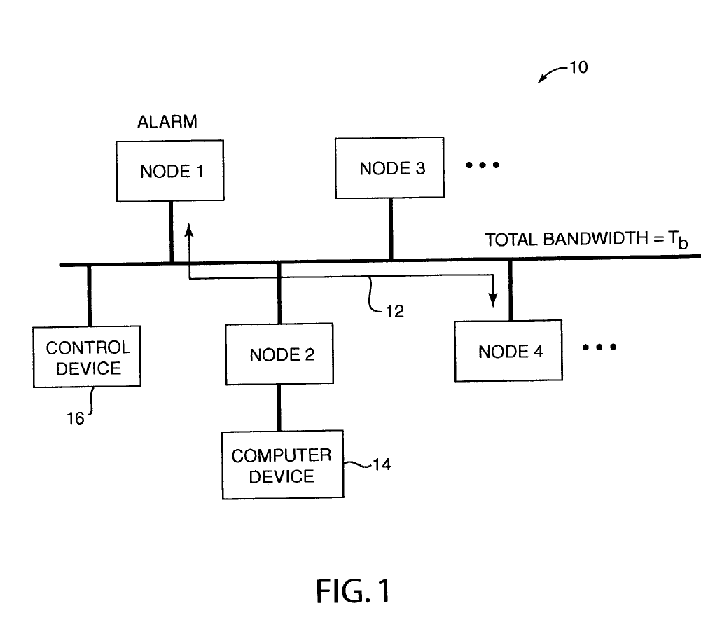

FIG. 1 is a block diagram illustrating a simple computer network 10 having multiple nodes, four of which are shown in the Figure. Node 1 and Node 4 are communicating data there between, as indicated by arrow 12. A computer system, processor, or other device 14 can be provided at one or more of the nodes to send and/or receive data over the network; or the node can be gateway to other nodes on the network. Thus, the term “network” as used herein can refer to a network of many types of devices in communication (bi- or unidirectional), including computers and/or other electronic devices.

When Node 1 is “alarmed” due an alarm condition existing at that node, according to the present invention Node 1 is dynamically assigned more network bandwidth, allowing Node 1 to transmit and/or receive more of the necessary data relating to the alarm condition in less time; i.e., priority for transmission and reception of data at the node dynamically increases on the network. For example, when a video camera sensor at Node 1 senses an alarm condition, video and/or audio data can be transmitted from Node 1 to Node 4 at a much higher rate than under normal conditions when Node 1 is not allocated additional bandwidth.

In one exemplary method of allocating bandwidth to an alarmed network node (Node 1 in FIG. 1), the amount of bandwidth Tₐ to allocate can be determined using predetermined relationships. In this example, the total dynamically allocatable network bandwidth Dₐ can be defined to be a proportion of the total network bandwidth T_{b}, such that

Dₐ=X*T_{b}, (1)

where X can, for example, have a value between 0 and 1. The allocatable bandwidth Dₐ can vary depending on the implementation of a network, its applications, etc. The detected alarm condition is determined to be of a type of alarm condition that has a predetermined priority level assigned thereto. The priority level is in accordance with the severity of the alarm condition and/or can take into account other factors. The priority level of the alarm condition can be represented by Aₚ, which is a number scaled in accordance with the priority of the alarm condition. For example, Aₚ can have a value between 0 and 1 to indicate the priority, where 1 is the highest possible priority.

The bandwidth Tₐ to be allocated to the alarmed node can be determined based on the alarm priority Aₚ and the dynamically allocatable network bandwidth Dₐ:

Tₐ=Aₚ*Dₐ (2)

The resulting allocatable network bandwidth Tₐ can then be assigned to Node 1, and causing in some cases the reduction of bandwidth for other nodes on the network as appropriate.

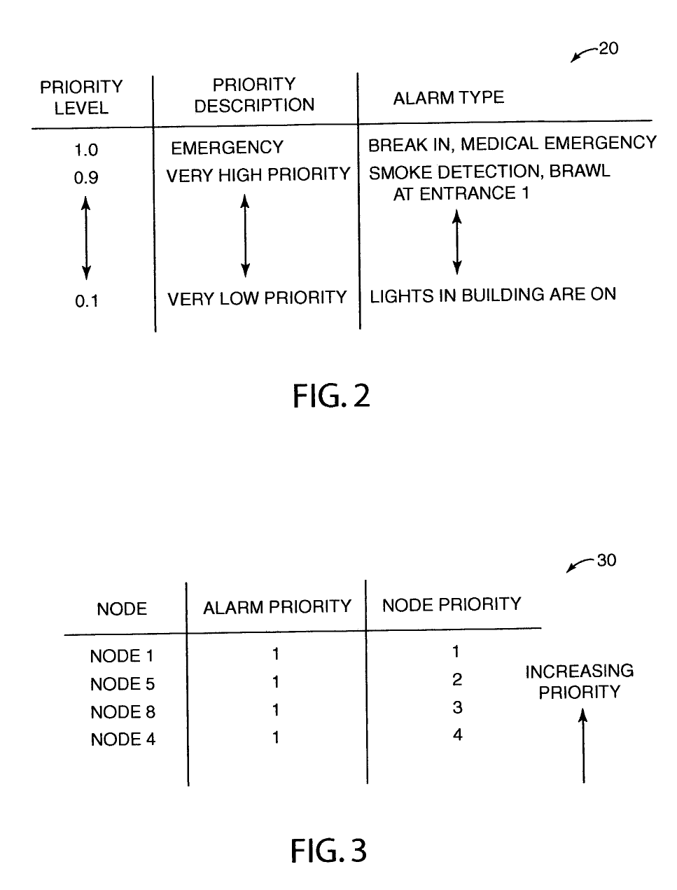

FIG. 2 illustrates a table 20 that shows one exemplary method of priority assignment to various possible alarm sources (i.e., alarm types) that may be relevant to the network 10. The potential types of alarms on the network can be prioritized in order that the bandwidth allocation can be achieved in a consistent manner. These priorities can be dynamically determined, i.e. determined while the network is operating, e.g., by looking up the type of alarm in a table to find its priority level, such as in table 20. Other methods can also be used to determine the priority level of detected alarm conditions.

In one embodiment, one or more control devices 16, as shown in FIG. 1, can be connected to the network 10 to act as a network bandwidth controller and have all or a subset of the priorities of table 20 assigned to a list of alarm sources known to the controller. When an alarm condition occurs, device 16 raises the bandwidth requirements in accordance with the priority of the type of the alarm condition. Bandwidth can be raised for the transmitting node and the receptor node (and any other nodes needed) to allow the data transfer to take place. For example, a computer system or device 16 can monitor the nodes to determine when an alarm has occurred, as is well known to those of skill in the art. Alarm information that indicates the type of alarm can be sent to the device 16 from any alarmed node, which in turn has obtained the alarm information from one or more alarm sensors (such as software or hardware sensors). Or, each node or a group of nodes can have a device 16 connected to monitor any alarm sensors connected to that node, and the devices 16 can report to a central controller or may be authorized to adjust bandwidth themselves.

In the example of table 20, an alarm condition of “lights turned on” in a monitored premises is of low priority, while an alarm condition of a break-in of the monitored premises, or an emergency of a medical nature, is of the highest priority. These alarms and priorities can be assigned to any desired conditions and prioritized in any desired order. Of course, many characteristics of different alarm conditions besides or addition to the type of alarm can be used to assign priorities. For example, priority can be assigned based on the severity or potential destructiveness of alarm conditions, so that a large fire would be assigned a higher priority than a small fire, which would be assigned a higher priority than smoke with no fire; or an unauthorized break-in at a particular high-security door would be assigned a higher priority than a break-in at a low-security door.

The bandwidth requirements of an alarm condition for nodes are determined based on the determined priority level of the alarm condition as well as other factors. For example, there may be a number of other parameters that can affect the bandwidth requirements of a particular alarm condition at a particular node. For instance, even if a particular alarm has the highest level of alarm priority, the amount of data to be transmitted over the network may not require higher bandwidth or may require higher bandwidth only for a short period of time, so that, for example, less or no additional bandwidth need be allocated to the alarmed node, or high bandwidth need be allocated only very briefly. There can be other factors or applications requiring different adjustments to required bandwidth. All these types of parameters can be used in the network protocol to provide satisfactory levels of guaranteed service during alarm conditions. Under many circumstances one or more multipliers can be assigned for associated conditions on a network for particular alarm conditions to determine the bandwidth requirements for an alarmed node, where the required bandwidth is multiplied by a multiplier when particular conditions are met.

If there are two or more alarmed nodes having different types of alarms and therefore different priorities, bandwidth can be divided between these alarmed nodes, where the amount of additional bandwidth allocated to each alarmed node is based on the priority levels of the alarm at that node, and where the higher priority alarms first receive any available bandwidth. For example, the amount of additional bandwidth allocated can be determined using equation (2) above and is thus in proportion with the predetermined priority level of the alarm condition (indicated in the table 20 of FIG. 2). An alarm type of “smoke detected” would have a priority of 0.9 in this example. For the purposes of this example, assume the bandwidth requirements of the alarm are as high as possible, so that the full required bandwidth of 90% of the total allocatable bandwidth Dₐ is needed. If another type of alarm condition existed at the same time as the smoke alarm, such as an alarm having a priority level of 0.5, that alarm condition could presently be assigned the remainder of the dynamically allocatable bandwidth (which would be 10% of the total allocatable bandwidth), and this lower-priority alarm condition may have to wait until the smoke alarm condition had passed before any more of the allocatable bandwidth could be assigned to it.

Dynamic allocation of network bandwidth according to the present invention has great advantages in achieving efficiency during alarm and emergency conditions, and even greater advantages when alarm conditions require the transmission of large amounts of data, such as video and audio data.

FIG. 3 illustrates a table 30 that shows examples of priorities that can be assigned for the resolution of conflicts in alarm priority. There is a possibility of contention of a number of nodes on the same network when these nodes have the same alarm condition, with the same bandwidth requirements, all at the same time. The network preferably has a predetermined scheme for dealing with such occurrences. One method to resolve these types of conflicts is to allow the node that captures the network bandwidth first to use that bandwidth first. In many circumstances, however, this method may not be satisfactory. In another method, a predetermined conflict resolution priority assigned to nodes of the network can be used to allow for an orderly resolution of any such conflicts.

For example, the table 30 of FIG. 3 illustrates that Nodes 1, 5, 8 and 4 are all alarmed at the same time with the same level of alarm priority (1) and all request the same (or similar) amount of network bandwidth (i.e., all have the same or similar bandwidth requirements). Since these nodes all have the same alarm priority, the conflict must be resolved using a predetermined method, such as the use of a look-up table like table 30, e.g. the conflict can be resolved dynamically using this table. In table 30, the preassigned conflict priorities for the nodes indicate that Node 1 has the right to be serviced first, Node 5 second, Node 8 third, and Node 4 fourth. The controller(s) 16 then assign bandwidth to Node 1 for as long as necessary (it may be necessary to sustain the alarm condition for a time period), followed by Node 5, Node 8, and last, Node 4. Or these nodes can be allocated bandwidth in turn for smaller, sometimes pre-defined, time divisions. The order of the nodes may depend on network configuration, devices located at the nodes, or other factors. The implementation of such bandwidth assignment to nodes according to priorities can be accomplished in various ways, as is well known to those of skill in the art. In other embodiments, other types of methods can be used to resolve these types of conflicts between nodes having the same priority and similar bandwidth requirements.

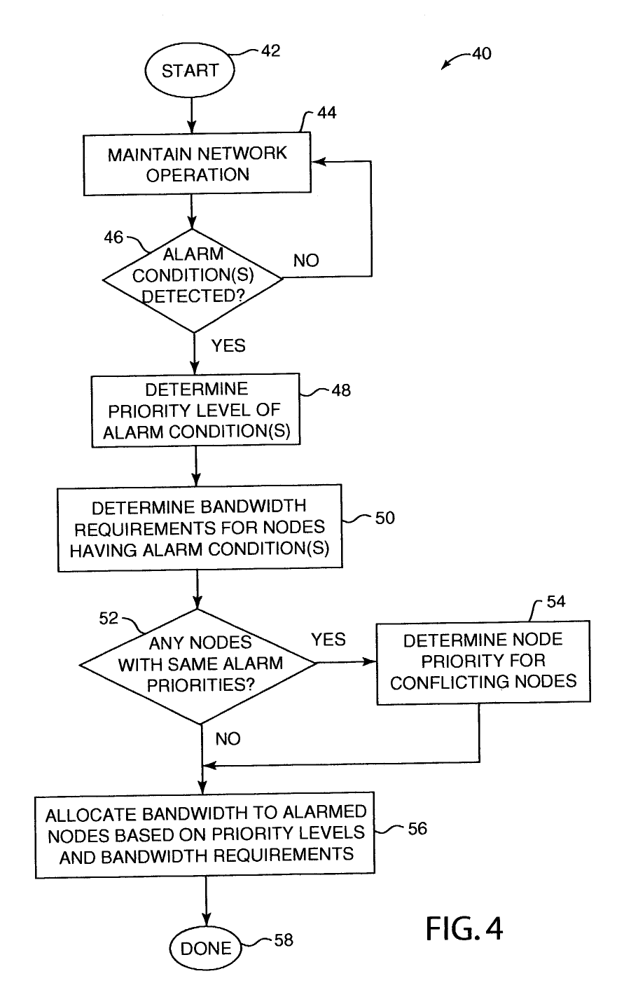

FIG. 4 is a flow diagram illustrating a method 40 of the present invention for allocating bandwidth under alarm conditions. The method begins at 42, and in step 44, the normal operation of the network is maintained. In step 46, it is checked whether one or more alarm conditions have been detected at any nodes on the network. As explained above, this can be accomplished in any of several ways, including using a control device 16 to receive sensor information, using multiple devices, such as at one or more nodes, to check sensor information and report to a control device, etc. If there is no alarm condition detected, then the method returns to step 44 to normal network operation and functionality.

Once an alarm condition is detected, then in step 48 the priority level of the alarm condition(s) are determined, e.g., dynamically, for example by using a table such as table 20 of FIG. 2, or by some other method. In step 50, the bandwidth requirements for the nodes having the alarm conditions are determined. The bandwidth requirements can be based on the priority level of the alarm condition, and also on one or more other factors. For example, as explained above, different applications may require less or more data than other applications, so that the full amount indicated by the priority level may not be needed (e.g., if using video or audio data, all the bandwidth may be needed, versus text data which needs significantly less). Also, the node having the alarm may have bandwidth requirements in addition to the requirements for the alarm condition. This step determines what actual bandwidth is needed based on the alarm condition, alarm sensor type, type of data, node location in the network, etc. This can be performed dynamically, based on the requirements at the time of the alarm.

In step 52, it is checked whether any of the alarmed nodes have the same alarm priority, i.e., whether a conflict for allocated bandwidth may be present. If not, or if there is only one alarmed node, then the process continues to step 56, detailed below. If there is a conflict for allocated bandwidth, then in step 54, node priorities are determined to resolve the conflict, e.g. dynamically determining node priorities using a table such as table 30 of FIG. 3 or a different predetermined relationship or method. If the multiple conflicting nodes have the same alarm priority level but have much different bandwidth requirements, then the conflict might be able to be resolved without having to resort to the node priority table (such as table 30).

The process continues to step 56, in which increased or additional bandwidth is allocated to the nodes having the alarm conditions, based on the priority level of the alarm conditions and the bandwidth requirements for the alarm conditions (and any node priority determined in step 54, if applicable). The bandwidth to be allocated can be determined, for example, using equation (2), and then modified by any multipliers or other factors as discussed above to achieve the final allocatable amount.

Although the present invention has been described in accordance with the embodiments shown, one of ordinary skill in the art will readily recognize that there could be variations to the embodiments and those variations would be within the spirit and scope of the present invention. The techniques of the present invention can be applied to many types of alarms and similar conditions. Accordingly, many modifications may be made by one of ordinary skill in the art without departing from the spirit and scope of the appended claims.

What is claimed is:

1. A method for allocating network bandwidth to nodes on a network under alarm conditions, the method comprising:
(a) determining that an alarm condition exists for at least one node on the network; and
(b) causing an increase in the network bandwidth allocation of the at least one node having the alarm condition.

2. The method of claim 1 wherein the alarm condition has a predetermined priority level based upon the type or other characteristic of the alarm condition.

3. The method of claim 1 further comprising determining a network bandwidth requirement for the at least one node having the alarm condition, and wherein the network bandwidth allocation of the at least one node is caused to be increased such that the bandwidth requirement is met.

4. The method of claim 3 wherein the bandwidth requirement of the node having the alarm condition is associated with a predetermined priority level of the alarm condition.

5. The method of claim 4 wherein the bandwidth required for the node having the alarm condition is, at least in part, proportionally based on the priority level of the alarm condition.

6. The method of claim 2 wherein each of a plurality of nodes on the network has a different type of alarm condition, each type of alarm condition having a different priority level, and further comprising a step of allocating additional network bandwidth to at least one of the nodes having an alarm condition based on the priority levels.

7. The method of claim 6 wherein the additional network bandwidth is first allocated to the node having the alarm condition with the highest priority, following by nodes having successively lesser priorities.

8. The method of claim 6 wherein the additional network bandwidth is proportionally allocated to the nodes having alarm conditions based at least in part upon the priority level of the alarm conditions.

9. The method of claim 6 wherein when a plurality of nodes having an alarm condition have the same priority and the same bandwidth requirements, the nodes are allocated the network bandwidth based on a predetermined order of nodes.

10. The method of claim 1 wherein additional network bandwidth provided to the node having the alarm condition is at least a portion of dynamically allocatable bandwidth that is a proportion of the total network bandwidth.

11. The method of claim 1 wherein the determining that an alarm condition exists includes receiving data derived from the use of alarm sensors in communication with the network.

12. The method of claim 11 wherein the at least one node having the alarm condition is in communication with at least one alarm sensor that has detected an alarm condition.

13. The method of claim 1 wherein the alarm condition includes an unauthorized entry onto a monitored premises.

14. The method of claim 1 wherein the alarm condition includes a destructive element sensed on a monitored premises.

15. A method for allocating network bandwidth to nodes on a network having one or more alarm conditions, the method comprising:
(a) determining a priority level for each alarm condition detected on the network;
(b) determining bandwidth requirements for nodes on the network which have an alarm condition; and
(c) causing an increase in network bandwidth allocation for each node having an alarm condition, the increased bandwidth being in accordance with the bandwidth requirement and the priority level of the alarm condition.

16. The method of claim 1 further comprising determining conflict resolution priorities to conflicting nodes on the computer network having the same level of priority and same bandwidth requirements, the conflict resolution priorities determining which of the conflicted nodes receive the increased bandwidth allocation.

17. The method of claim 15 wherein each alarm condition has a predetermined priority level based upon the type or other characteristic of the alarm condition.

18. The method of claim 15 wherein the bandwidth requirements for each node having an alarm condition is based at least in part on the type or amount of data transmitted during the alarm condition.

19. The method of claim 17 wherein a plurality of nodes on the network have at least two different alarm conditions, each type of alarm condition having a different priority level, wherein the additional network bandwidth is first allocated to the node having the alarm condition with the highest priority, following by nodes having successively lesser priorities.

20. The method of claim 15 wherein an alarm condition is detected based on the reception of data derived from the use of alarm sensors in communication with the network, wherein the at least one node having the alarm condition is in communication with at least one alarm sensor that has detected the alarm condition.

21. A method for allocating network bandwidth to nodes on a network, the method comprising:
(a) determining a priority level of an alarm condition detected at one or more nodes on the network;
(b) assigning bandwidth requirements to each node having an alarm condition, wherein the bandwidth requirements are based, at least in part, on the priority level of the associated alarm condition; and
(c) causing an allocation of additional bandwidth to the one or more nodes having the alarm condition, the amount of additional bandwidth being in accordance with the bandwidth requirement of the node having the alarm condition.

22. The method of claim 21 further comprising assigning priority levels to different types or characteristics of alarm conditions.

23. The method of claim 21 further comprising assigning conflict resolution priorities to the nodes on the computer network, wherein the conflict resolution priorities govern which nodes having alarm conditions with the same level of priority receive the increased bandwidth allocation.

24. The method of claim 22 wherein each of a plurality of nodes on the network has a different type of alarm condition, each type of alarm condition having a different priority level, wherein the additional network bandwidth is first allocated to the node having the alarm condition with the highest priority, following by nodes having successively lesser priorities.

25. The method of claim 21 wherein the bandwidth requirements for each node having an alarm condition is based at least in part on the type or amount of data transmitted during the alarm condition.

26. A system for allocating network bandwidth to nodes on a network, the system comprising:
means for determining that an alarm condition exists for at least one node on the network; and
means for causing the increase of the network bandwidth allocation of the at least one node having the alarm condition.

27. The system of claim 26 wherein the alarm condition has a predetermined priority level based upon the type or other characteristic of the alarm condition.

28. The system of claim 26 further comprising means for determining a network bandwidth requirement for the at least one node having the alarm condition, wherein the network bandwidth allocation of the at least one node is increased such that the bandwidth requirement is met.

29. The system of claim 28 wherein the bandwidth requirement of the node having the alarm condition is associated with a predetermined priority level of the alarm condition.

30. The system of claim 27 wherein each of a plurality of nodes on the network has a different type of alarm condition, each type of alarm condition having a different priority level, and further comprising means for allocating additional network bandwidth to at least one of the nodes having an alarm condition based on the priority levels.

31. The system of claim 30 further comprising means for determining a priority of nodes for bandwidth allocation when a plurality of nodes have an alarm condition with the same priority and the same bandwidth requirements.

32. The system of claim 26 wherein additional network bandwidth provided to the node having the alarm condition is at least a portion of dynamically allocatable bandwidth that is a proportion of the total network bandwidth.

33. The system of claim 26 wherein the means for determining that an alarm condition exists includes means for receiving data derived from the use of alarm sensors in communication with the network.

34. The system of claim 33 wherein the at least one node having the alarm condition is in communication with at least one alarm sensor that has detected an alarm condition.

35. A computer readable medium including program instructions allowing a computer to allocate network bandwidth to nodes on a network under alarm conditions, the program instructions performing the steps comprising:
(a) determining that an alarm condition exists for at least one node on the network; and
(b) causing an increase in the network bandwidth allocation of the at least one node having the alarm condition.

36. The computer readable medium of claim 35 wherein the alarm condition has a predetermined priority level based upon the type or other characteristic of the alarm condition.

37. The computer readable medium of claim 35 wherein the program instructions further performing a step of determining a network bandwidth requirement for the at least one node having the alarm condition, and wherein the network bandwidth allocation of the at least one node is caused to be increased such that the bandwidth requirement is met.

38. The method of claim 37 wherein the bandwidth requirement of the node having the alarm condition is associated with a predetermined priority level of the alarm condition.

39. The method of claim 36 wherein each of a plurality of nodes on the network has a different type of alarm condition, each type of alarm condition having a different priority level, and further comprising a step of allocating additional network bandwidth to at least one of the nodes having an alarm condition based on the priority levels.

40. The method of claim 39 wherein the additional network bandwidth is first allocated to the node having the alarm condition with the highest priority, following by nodes having successively lesser priorities.

41. The method of claim 39 wherein when a plurality of nodes having an alarm condition have the same priority and the same bandwidth requirements, the nodes are allocated the network bandwidth based on a predetermined order of nodes.

42. The method of claim 35 wherein the determining that an alarm condition exists includes receiving data derived from the use of alarm sensors in communication with the network.
